(19) United States
(12) Patent Application Publication
(10) Pub. No.: US 2021/0398084 A1
(43) Pub. Date: Dec. 23, 2021

(54) TIME ACTIVITY PROCESSING

(71) Applicant: SAP SE, Walldorf (DE)

(72) Inventors: Hagen Eck, Heidelberg (DE); Antje Bredehoeft, Malsch (DE); Ralf Missal, Lampertheim (DE); Volker Ruof, Besigheim (DE)

(73) Assignee: SAP SE, Walldorf (DE)

(21) Appl. No.: 16/906,635

(22) Filed: Jun. 19, 2020

(51) Int. Cl. G06Q 10/10

(52) U.S. Cl. CPC G06Q 10/1091

(57) ABSTRACT

Systems, methods, and computer media for processing time activities are provided herein. Time activities, each having a type and a timestamp, can be received. Based on the types and timestamps, a time activity pair can be formed, and a time interval can be generated corresponding to the time activity pair. Time intervals can have a classification. Activity for a time period can thus be determined through pair formation and time interval generation using the time activities received during the time period. A time tracking application account can be updated to include the generated time intervals.

### BACKGROUND

Time tracking is increasingly accomplished through computer hardware and software. Time activities, such as an employee clocking in or clocking out, can be gathered through hardware terminal devices, application user interfaces, or other approaches. Discrete time activities, however, provide limited information about an employee's work status or work history.

### BRIEF DESCRIPTION OF THE DRAWINGS

FIG. 1 illustrates an example method of processing time activities.

FIG. 2 is a timeline illustrating pair formation for a series of time activities.

FIG. 3 is a timeline illustrating a series of time activities and resulting time intervals.

FIG. 4 illustrates an example time activity processing system in which time activities are received via a terminal or application user interface.

FIG. 5 illustrates an example method of processing time activities in which activity pairs are formed from time activities and time intervals are generated based on the activity pairs.

FIG. 6 illustrates an example method of processing time activities in which time activities are compared to a most recent prior time activity, and time intervals are generated based on the comparison.

FIG. 7 is a diagram illustrating a generalized implementation environment in which some described examples can be implemented.

### DETAILED DESCRIPTION

The examples described herein process time activities to generate meaningful work status and attendance information that is used to update accounts in a time tracking software application. Many entities use distributed systems for access control and time recording. Typically, these systems consist of specialized terminals for identifying and registering employees and other users. Employee identification can be done, for example, using key cards. Although such terminals can be used for recording time activities, the systems controlling the terminals are not typically designed for time tracking and time management. Instead, they are intended for access control, key card distribution, and other security purposes. The described examples solve the computer-based problem of how to process time activity data to accurately determine work or attendance status throughout a day or other time period. The described examples provide an efficient, centralized approach to handling time activity data that also allows for integration with, for example, a centralized human resources application(s).

Time activities are data reflecting activities that have occurred in a time tracking context. Time activities can include, for example, a timestamp, indicating an occurrence time of the activity, an identifier of a user associated with the activity, a location of the activity (e.g., location of a terminal where a user has clocked in), as well as other attributes. Examples of other attributes include a type, such as “attendant” (indicating the user's presence at, e.g., a workplace or other location) and “non-attendant” (indicating the user is absent or has left a workplace or other location). Example attendant activities include “clock-in,” “break,” “lunch,” “short work trip,” etc. Example non-attendant activities include “clock-out” and “leave” or “vacation time.”

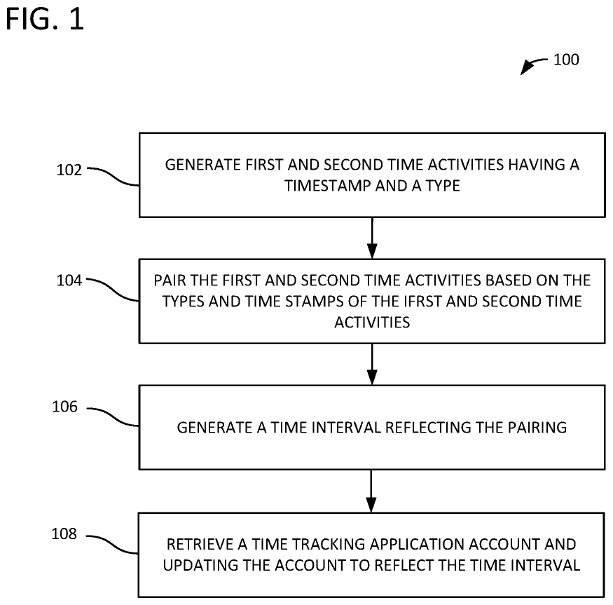

By analyzing the activity types and timestamps of received time activities, pairs can be formed between time activities. A time interval can be generated for the time period bounded by the time activities of a pair. In contrast to individual time activities, which can be thought of as a snapshot in time, time intervals represent a duration, having a start and end time along with a classification (e.g., working/standard attendance, at lunch, absent, etc.). The classification can be determined, for example, from the activity types or other information associated with the time activities the time interval is formed from. Time intervals for a user can then be used to update a time tracking application to reflect the correct amount of work time, leave, etc. for the user. Examples are described below with reference to FIGS. 1-7.

FIG. 1 illustrates a method 100 of processing time activities. In process block 102, first and second time activities are generated. The first and second time activities have a time stamp and a type. The time stamp of the second time activity is after the time stamp of the first time activity. As an example, the first time activity can be an “attendant” type clock-in activity at 8:00 am, and the second time activity can be a “non-attendant” type clock-out activity at 5:00 pm. The first and second time activities can be generated, e.g., based on one or more user interactions with a terminal device (e.g., swiping an access card), through a time tracking application user interface interaction (e.g., entry by a user in a web or local application), through time entry in a mobile app, through detection of an RFID tag, or other approach. Activities can be identified as attendant or non-attendant based on actions taken by the user (e.g., selecting a clock-in, break, lunch, etc. option) or based on other information such as time of day or last known time activity type (e.g., card swipes between 6 am and 10 am are automatically assumed to be attendant clock-in activities if the first time activity of the day, the first time activity after a clock-out activity is assumed to be a clock-in activity, etc.).

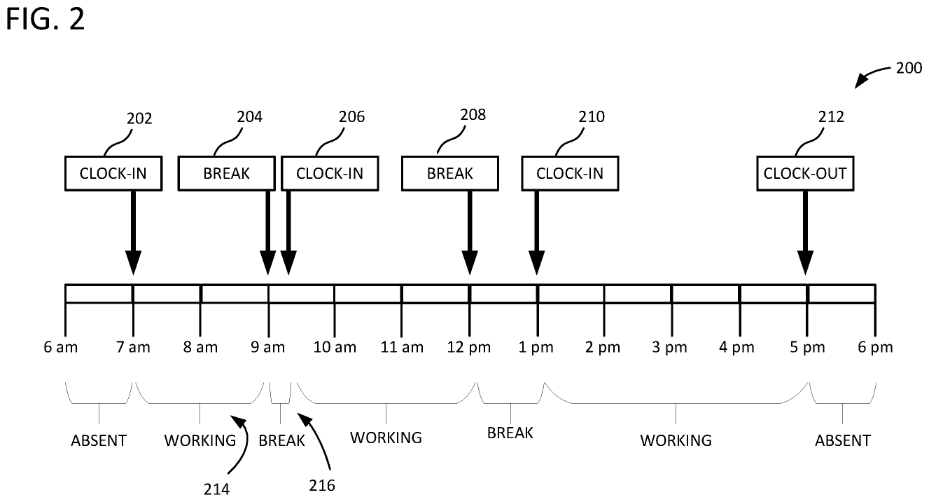

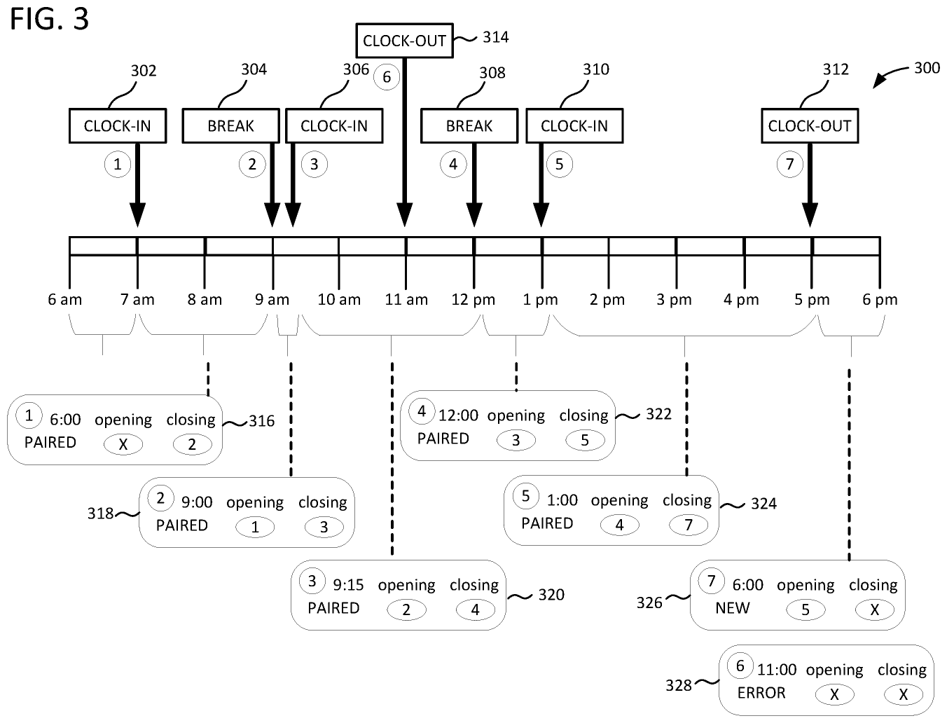

In process block 104, the first and second time activities are paired based on the types and timestamps of the first and second time activities. A time interval reflecting the pairing is generated in process block 106. Examples of time intervals are shown in detail in FIGS. 2 and 3. In process block 108, a time tracking account is retrieved (e.g., from a data store of account information for users of the time tracking account) and is updated to include the time interval. In some examples, the time tracking account includes one or more timesheets, and a timesheet for is updated to include the generated time interval. In some examples, a graphical user interface provided by the time tracking application is modified to reflect the time interval. For example, a work/attendance or leave total can be updated or a work/attendance bar graph or other data visualization can be updated.

A time interval corresponds to the time between the time activities that bound the interval. The time interval can also have a classification to describe the time interval. Example classifications include working, at lunch, absent, on break, at jobsite, leave/vacation, etc. Example classifications are shown in FIG. 2. In some examples, time intervals include an interval opening field and an interval closing field. The interval closing field can be, for example, a reference (such as an activity identifier) to the later of the two time activities that form the time interval. Similarly, the interval opening field can be a reference to the earlier of the two time activities that form the time interval. In some examples, the interval opening field is a reference to the previous time interval so that as time intervals are generated, a relationship is maintained between the time intervals. An example of this approach is illustrated in FIG. 3. Other fields or attributes can also be added to time intervals.

As an example of time interval generation, for two time activities, when the first (in time) time activity is attendant and the second time activity is non-attendant, the time interval is classified as standard attendance representing a clock-in followed by a clock-out. As another example, when both the first and second time activities are attendant, the time interval can be classified as modified attendance representing one of a clock-in followed by a break, a break followed by a clock-in, or a work type change (e.g., leaving a location to go to a jobsite). As yet another example, when the first time activity and the second time activity have a timestamp in the same day, the first time activity is non-attendant, and the second time activity is attendant, the time interval can be classified as leave. This can represent, for example, a user clocking out, running personal errands, and clocking back in.

The following general rules can be applied for attendant (AT) and non-attendant (NAT) time activities. If an AT activity follows a NAT activity, this represents the standard clock-in activity, and a new period of attendance starts. If an AT activity follows an AT activity, the person is still at work, but the nature of the attendance has changed (e.g., from working to break). This implies the end of the previous attendance and allows a pair formation. If a NAT activity follows an AT activity, this is the standard clock-out activity and allows pair formation. If a NAT activity follows a NAT activity, an error is flagged for intervention/review. This information is summarized in Table 1, below, where T₀ is the last existing activity and T is the newly arrived activity.

TABLE 1
Time Interval Formation Scenarios

| Last Existing | | New Arriving | | | |
|---|---|---|---|---|---|
| Time Activity | | Time Activity | | | |
| Category | Time | Category | Time | Result | Explanation |
| AT/NAT | T₀ | AT/NAT | T < T₀ | ERROR | The time activity is accepted by the |
| | | | | | system but marked as deficient |
| | | | | | because the time is before the last |
| | | | | | registered activity. |
| AT | T₀ | AT | T > T₀ | OK | The time activity ends the current |
| | | | | | time period and starts a new time |
| | | | | | period. |
| NAT | T₀ | AT | T > T₀ | OK | The time activity starts a new time |
| | | | | | period. |
| AT | T₀ | NAT | T > T₀ | OK | The time activities ends the current |
| | | | | | time period. |
| NAT | T₀ | NAT | T > T₀ | ERROR | The time activity will be accepted by |
| | | | | | the system, but marked as deficient, |
| | | | | | because no AT activity is matching |
| | | | | | it. |

In examples using an interval opening field and an interval closing field, formation of pairs that bound a time interval can be performed as follows. If the activity type of the most recent previous time activity is AT and a new time activity is received, a time interval is formed, marked as “paired,” and the activity identifier of the new time activity is used in the interval closing field of the time interval. The activity identifier of the previous time activity is used in the interval opening field of the time interval. In examples in which the interval opening field references the previous time interval, an identifier of the previous time interval is used. If the activity type of the new time activity is AT, then the new time activity is marked as “new” (or an incomplete time interval is started with a “new” designation and a reference to the previous time interval in the interval opening field). If the activity type of the new time activity is NAT, then the new time activity is marked as “paired” (and/or the time interval is marked as paired). In some examples, each time activity has a field that can be new, paired, or error that indicates whether the time activity has been paired with another time activity to form a time interval.

In some examples, time intervals also indicate either new (e.g., incomplete), paired, or error. When several time activities are in sequence, a time activity in the middle will be part of two different time intervals (one with an time activity before, and one with a time activity after). After the time activity is paired in the first instance to create a time interval, a new time interval (which can be incomplete if more time activities have not been received yet) can be created that references the previous time interval (or the time activity) so that the starting point for the next time interval is maintained.

FIG. 2 illustrates a timeline 200 on which several time activities have occurred for a user throughout a day: clock-in activity 202, break activity 204, clock-in activity 206, break activity 208, clock-in activity 210, and clock out activity 212. The activity type can be provided along with the occurrence time (e.g., through user selection or rules-based selection). From the time activities, time intervals can be formed. For example, time interval 214 is formed by pairing clock-in activity 202 and break activity 204 and has a classification of “working” or “standard attendance.” Similarly, time interval 216 is formed by pairing break activity 204 and clock-in activity 206 and has a classification of “break.”

FIG. 3 illustrates a timeline 300 similar to that shown in FIG. 2. Rather than time interval classifications, however, FIG. 3 illustrates time intervals with identifiers, interval opening fields, interval closing fields, interval starting time, and a status. In FIG. 3, several time activities are shown: clock-in activity 202, break activity 304, clock-in activity 306, break activity 308, clock-in activity 310, clock out activity 312, and clock out activity 314. The time activities also have an identifier (1-7) indicating when in time the activity was received. Time intervals 316, 318, 320, 322, 324, 326, and 328, formed from the time activities, are also shown. Clock out activity 314 represents a time activity received out of order and is not reflected in the time intervals (except for time interval 328). The identifier used for a time interval is the identifier of the earlier of the two time activities that form the time interval.

Time interval 316 corresponds to the time interval formed by pairing clock-in activity 302 and break activity 304. Time interval 316 has an identifier “1,” which is the identifier of clock-in activity 302, a status of “PAIRED,” an occurrence time of the first activity of “6:00,” no interval opening field value, and an interval closing field value of “2,” which is the identifier associated with break activity 304. In some examples, instead of using the identifier of the earlier time activity, a separate identifier is used. Time interval 316 does not have an interval opening field value because it is the first activity of the day. In some examples, AT activities after NAT activities (e.g., clocking in for the day) do not have a value for the interval opening field, and in some examples, only the first time interval of the day has no value for the interval opening field.

Similar to time interval 316, time interval 318 has an identifier of “2,” which is the identifier of the earlier of the two time activities that form the interval, an occurrence time for the earlier time activity of “9:00,” a status of “PAIRED,” an interval opening field value of “1,” which is the identifier of the previous time interval, and an interval closing field value of “3.” Although not shown, the classification for time interval 318 is “break” based on the activity types of break activity 304 and clock-in activity 306. As with time interval 316, the interval closing field value is 3 because the activity with the identifier “3” was the second time activity of the pair that resulted in time interval 318. Similarly, the interval opening field of time interval 318 is 1 because 1 is the previous time interval. In examples where the interval opening field uses the closing activity of the previous time interval as the interval opening field value, a “2” could be used. Time intervals 320, 322, 324, and 326 follow a similar pattern.

Clock-out activity 314 was generated out of order (e.g., based on information received out of order) and has a timestamp between clock-in activity 306 and break activity 308. Because there are already later time activities in the system that have been paired with clock-in activity 306, time interval 328 is created showing the status as “ERROR” and an identifier of “6.” In some examples, administrator review is used to resolve errors. In some examples, when an out-of-order time activity is generated, an existing time interval is segmented. In this example, time interval 320 would be segmented and the interval closing field changed to “6.” A new time interval would then be inserted referencing identifier “3” for the interval opening field value and “4” for the interval closing field value.

Even though clock-out activity 314 was determined to be an error, clock-out activity 312, which has an identifier of “7,” indicating it was generated after clock-out activity 314, is still processed and paired to create time interval 324 and start a new time interval 326.

In some examples, time activities are generated, pairs are formed, and time intervals created as appropriate. In other examples, time activities are generated periodically (e.g., once per day, twice per day, hourly, etc.) based on received information. In some examples a staggered approach is used where not all time activities are generated at once to avoid system overload (e.g., many clock-in activities between 8:00 and 8:30 am).

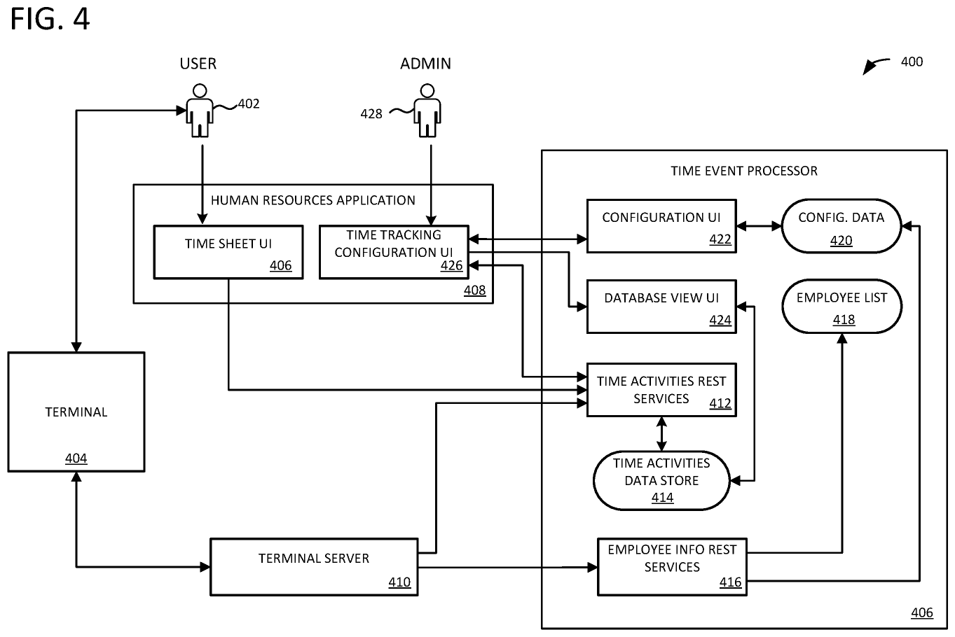

FIG. 4 illustrates an example system 400 configured to process time activities. User 402 can cause time activities to be generated by swiping an access card or other interaction with terminal 404. Time activity “generation” can also refer to actions that cause generation of a time activity. Terminal 404 is a hardware device that can provide access control to a building, room, level, etc. In some examples, terminal 404 is specific to timekeeping. User 402 can also cause a time activity to be created through time sheet UI 406 of human resources application 408. Time activities caused to be generated via terminal 404 are uploaded to terminal server 410 and communicated to time activities representational state transfer (REST) services 412 in time activity processor 414. Other architectures can also be used. Time activities REST services 412 receives, updates, and returns time activities, as well as combining time activities into time intervals and transferring them to human resources application 408. Time activities REST services 412 also stores time activities and time intervals in time activities data store 414.

In some examples, time activity processor 406 acts as a proxy system for external systems creating time activities, including time recording systems, access control systems, and mobile applications. For the external systems, time activities are accepted for storage, account balances can be provided as a response to time activities, and employee information can be provided. Employee information can be provided via employee information REST services 416, employee list 418, and configuration data 420 (individual configuration settings).

In some examples, time activity processor 406 sends external time intervals for time valuation, provides access to stored time activities, e.g. for checking whether everyone did show up, or for employees to double-check their recorded activities. This can be done through configuration UI 422, database view UI 424, or time sheet UI 406. Configuration UI 422 can be directly integrated into time tracking configuration UI 426, which is accessible by administrator 428. Time activity processor 406 can request data needed for configuration and employee database population from human resources application 408 by, for example, Compound API, direct OData queries, or other approaches. In some examples, time activity processor 406 is part of human resources application 408. In FIG. 4, arrows are shown at the end of connectors between system elements. These are for example only—any of the system components shown in FIG. 4 can be in communication with each other.

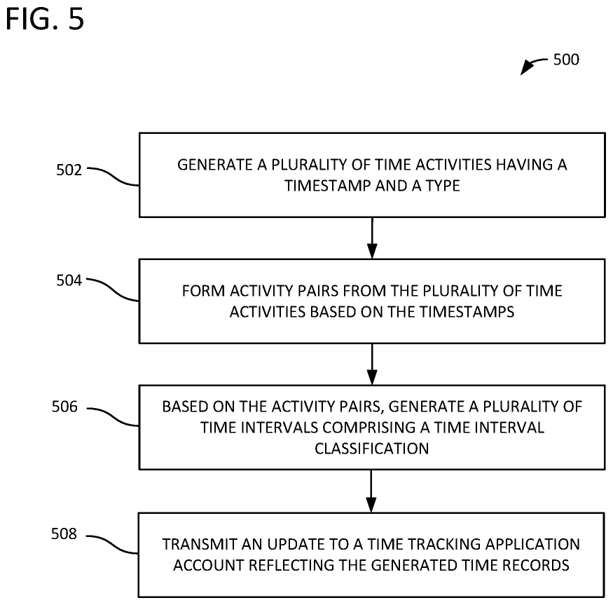

FIG. 5 illustrates a method 500 of processing time activities. In process block 502, a plurality of time activities are generated. The respective time activities have a timestamp and a type. In process block 504, activity pairs are formed from the plurality of time activities based at least in part on the timestamps (e.g., sequential activities are paired). Based on the activity pairs, a plurality of time intervals are generated in process block 506. The respective time intervals comprise a time interval classification determined based on the types of the time activities corresponding to the time interval. In process block 508, an update is transmitted to a time tracking application account reflecting the generated time intervals.

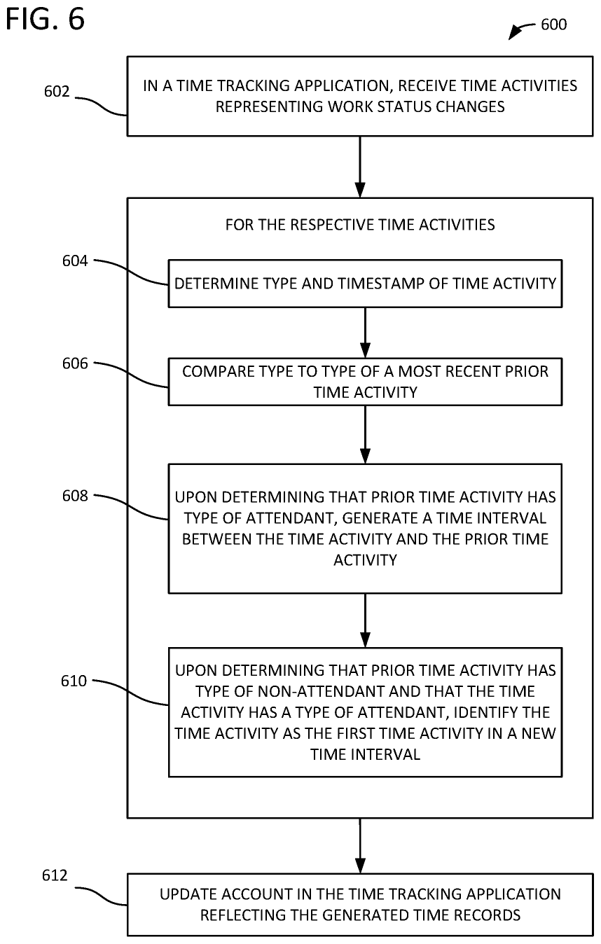

FIG. 6 illustrates a method 600 for processing time activities. In a time tracking application, a plurality of time activities are received in process block 602. The plurality of time activities represent work status changes. Process blocks 604, 505, 608, and 610 are performed for the respective time activities. In process block 604, a type and a timestamp of the time activity are determined. In process block 606, the type of the time activity is compared to the type of a most recent prior time activity. Upon determining that the prior time activity has a type of attendant, a time interval between the prior time activity and the time activity is generated in process block 608. The time interval references the time activity in an interval closing field. Upon determining that the prior time activity has a type of non-attendant and that the time activity has a type of attendant, the time activity is identified as a first time activity in a new time interval in process block 610. In process block 612, an account in the time tracking application is updated to reflect the generated time intervals.

The described approaches can occasionally experience errors caused by incomplete information, lost activities, or other reasons. One such situation is the “missing clock-in error” where a NAT activity is received without a previous AT activity. This situation can be rectified by either deleting the activity or providing an additional AT activity to create a valid pair. The time tracking application user interface can allow a user to enter any AT activity, which is configured for this user, with a time between the deficient NAT activity and the previous time activity.

Another situation, discussed with respect to FIG. 3, is an intermediate activity. In some examples, intermediate time activities are not rejected because there might be reasons for those activities to be received later. One example of an intermediate time activity is that a later received or generated time activity has a timestamp that places it inside a pair. The previous time activity is AT in this example. If the deficient time activity is AT and the following activity is not marked as ERROR, then it can be patched into the existing time pair by exchanging the references of the interval closing field of the previous and the interval opening field of the following time interval. If the deficient time activity is NAT, it can be used to shorten the existing time period by using it as the closing of the previous time interval and deleting the opening of the following time interval.

In this next example, the previous activity is NAT (e.g., a clock-out), the later activity is AT (e.g., a clock in), and the intermediate activity is outside a pair (e.g., no pair formed between the clock out and the clock-in). If the deficient time activity is AT and the following activity is also AT and not marked as error then the following actions can be taken: allow insertion of a NAT after the deficient activity but before the following activity; allow pairing of the deficient activity with the following activity (variant of missing clock-in); or allow replacing the later activity with the deficient activity. If the deficient activity is AT and the later activity is instead NAT and marked as ERROR, the deficient activity can be paired with the deficient NAT activity.

Another error case that can occur is when additional time activities are received even though there are already later activities. In the one special case described just above (the AT arriving or being generated after the NAT which marks both as ERROR), it is possible to repair two faulty time activities in one step. In other cases, time activities may need to be considered on a case-by-case basis.

### Example Computing Systems

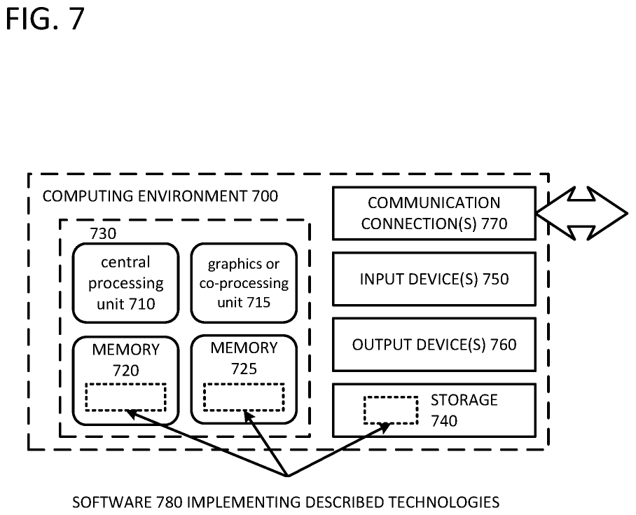

FIG. 7 depicts a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s). For example, memory 720 and 725 can store time activity processor 406 of FIG. 4.

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information and which can be accessed within the computing system 700. The storage 740 stores instructions for the software 780 implementing one or more innovations described herein. For example, storage 740 can store time activity processor 406 of FIG. 4.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections (e.g., 770).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. A method of processing time activities, comprising:
generating first and second time activities, the first and second time activities having a time stamp and a type, wherein the time stamp of the second time activity is after the time stamp of the first time activity;
pairing the first and second time activities based on the types and time stamps of the first and second time activities;
generating a time interval reflecting the pairing; and
retrieving a time tracking application account and updating the account to reflect the time interval.

2. The method of claim 1, wherein available types of the first and second time activities include attendant and non-attendant.

3. The method of claim 2, wherein when the first time activity is attendant and the second time activity is non-attendant, the time interval is classified as standard attendance representing a clock-in followed by a clock-out.

4. The method of claim 2, wherein when both the first and second time activities are attendant, the time interval is classified as modified attendance representing one of a clock-in followed by a break, a break followed by a clock-in, or a work type change.

5. The method of claim 2, wherein when the first time activity and the second time activity have a time stamp in the same day, the first time activity is non-attendant, and the second time activity is attendant, the time interval is classified as leave.

6. The method of claim 1, wherein the time interval comprises an interval opening field and an interval closing field.

7. The method of claim 6, wherein the interval opening field references a time interval chronologically prior to the first time activity.

8. The method of claim 6, wherein the interval closing field references the second time activity.

9. The method of claim 1, wherein the time interval comprises a classification field corresponding to work status of the user during the time interval.

10. The method of claim 1, wherein the first and second time activities are received from a terminal device based on one or more user interactions with the terminal.

11. The method of claim 1, wherein the time tracking application is a web application.

12. The method of claim 1, further comprising modifying a graphical user interface provided by the time tracking application to reflect the time interval.

13. A system, comprising:
a processor; and
one or more computer-readable storage media storing computer-readable instructions that, when executed by the processor, perform operations comprising:
generating a plurality of time activities, the respective time activities having a timestamp and a type;
forming activity pairs from the plurality of time activities based on the timestamps;
based on the activity pairs, generating a plurality of time intervals, wherein the respective time intervals comprise a time interval classification determined based on the types of the time activities corresponding to the time interval; and
transmitting an update to a time tracking application account reflecting the generated time intervals.

14. The system of claim 13, wherein a first of the activity pairs is formed by a first time activity having an type of attendant and a second activity having an type of non-attendant, and wherein the classification of the time interval corresponding to the first activity pair is standard attendance representing a clock-in followed by a clock-out.

15. The system of claim 13, wherein the respective time intervals comprise an interval opening field and an interval closing field.

16. The system of claim 13, wherein the interval opening field for the respective time intervals references another chronologically prior time interval.

17. The system of claim 13, wherein the plurality of time intervals span a workday and indicate a work status during the time intervals.

18. The system of claim 13, wherein upon receiving a time activity having a timestamp that falls inside an existing time interval, segmenting the existing time interval into two time intervals.

19. One or more computer-readable storage media storing computer-executable instructions for processing time activities, the processing comprising:
in a time tracking application, receiving a plurality of time activities, the plurality of time activities representing work status changes;
for the respective time activities:
determining a type and a timestamp of the time activity;
comparing the type of the time activity to the type of a most recent prior time activity;
upon determining that the prior time activity has a type of attendant, generating a time interval between the prior time activity and the time activity, wherein the time interval references the time activity in an interval closing field; and
upon determining that the prior time activity has a type of non-attendant and that the time activity has a type of attendant, identifying the time activity as a first time activity in a new time interval; and
updating an account in the time tracking application reflecting the generated time intervals.

20. The one or more computer-readable storage media of claim 19, wherein the processing further comprises: upon determining that the prior time activity has a type of non-attendant and that the time activity has a type of non-attendant, flagging the time activity as an error.
